(19) United States
(12) Patent Application Publication
(10) Pub. No.: US 2026/0246996 A1
(43) Pub. Date: Aug. 20, 2026

(54) AUDIO GENERATION

(71) Applicants: Beijing Zitiao Network Technology Co., Ltd., Haidian District (CN); Bytedance Technology Ltd., Grand Cayman (KY)

(72) Inventors: Xiaobin Zhuang, Beijing (CN); Zhuo Chen, Los Angeles, CA (US); Yuping Wang, Beijing (CN); Yuxuan Wang, Los Angeles, CA (US)

(21) Appl. No.: 19/542,536

(22) Filed: Feb. 17, 2026

(30) Foreign Application Priority Data
Feb. 18, 2025 (CN) 202510179793.6

(51) Int. Cl. H04N 21/43; G10L 13/047; G10L 25/30; G10L 25/57; H04N 21/44

(52) U.S. Cl. CPC H04N 21/43074; G10L 13/047; G10L 25/30; G10L 25/57; H04N 21/44008

(57) ABSTRACT

There are provided a method, an apparatus, an electronic device and a storage medium for generating audio. The method includes: processing video content with a video encoder to determine a video feature; and processing the video feature with a generation model to generate a target audio, where the video encoder is trained based on following processes: obtaining a sample video and a sample audio; determining a first feature representation of the sample video with the video encoder, and determining a second feature representation of the sample audio with an audio encoder; determining a training loss based on the first feature representation, the second feature representation, and reference information, the reference information indicating whether the sample video and the sample audio correspond to a same media file; and training the video encoder based on the training loss.

### CROSS-REFERENCE

This application claims the priority of Chinese Patent Application No. 202510179793.6, filed on Feb. 18, 2025, entitled “METHOD, APPARATUS, DEVICE AND STORAGE MEDIUM FOR GENERATING AUDIO”, the entire content of which is incorporated herein by reference.

### FIELD

Example embodiments of the present disclosure generally relate to the field of computers, and in particular, to audio generation.

### BACKGROUND

With the rapid development of computer technology, machine learning models may be applied to scenarios that require voice-over, such as film and television production, game development, advertisement creation, virtual reality, and augmented reality. The quality of audio generated by a machine learning model may be improved by gradually optimizing the machine learning model.

### SUMMARY

In a first aspect of the present disclosure, a method of generating audio is provided. The method includes: processing video content with a video encoder to determine a video feature; and processing the video feature with a generation model to generate a target audio, where the video encoder is trained based on following processes: obtaining a sample video and a sample audio; determining a first feature representation of the sample video with the video encoder, and determining a second feature representation of the sample audio with an audio encoder; determining a training loss based on the first feature representation, the second feature representation, and reference information, the reference information indicating whether the sample video and the sample audio correspond to a same media file; and training the video encoder based on the training loss.

In a second aspect of the present disclosure, an apparatus for generating audio is provided. The apparatus includes: a determination module, configured to process video content with a video encoder to determine a video feature; and a generation module, configured to process the video feature with a generation model to generate a target audio, where the video encoder is trained based on following processes: obtaining a sample video and a sample audio; determining a first feature representation of the sample video with the video encoder, and determining a second feature representation of the sample audio with an audio encoder; determining a training loss based on the first feature representation, the second feature representation, and reference information, the reference information indicating whether the sample video and the sample audio correspond to a same media file; and training the video encoder based on the training loss.

In a third aspect of the present disclosure, an electronic device is provided. The device includes at least one processor; and at least one memory coupled to the at least one processor. The at least one memory stores instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon. The computer program is executable by a processor to perform the method of the first aspect.

It would be appreciated that the content described in the Summary section of the present disclosure is neither intended to identify key or essential features of embodiments of the present disclosure, nor is it intended to limit the scope of the present disclosure. Other features of the present disclosure would be readily envisaged through the following description.

### BRIEF DESCRIPTION OF DRAWINGS

The above and other features, advantages, and aspects of embodiments of the present disclosure would become more apparent in combination with the drawings and with reference to the following detailed description. In the drawings, the same or similar reference numerals denote the same or similar elements.

FIG. 1 illustrates a schematic diagram of an example environment in which embodiments of the present disclosure may be implemented;

FIG. 2 illustrates a flowchart of an example process of generating audio according to some embodiments of the present disclosure;

FIG. 3 illustrates a flow block diagram of an example process of generating audio according to some embodiments of the present disclosure;

FIG. 4 illustrates a flowchart of an example process of training a video encoder according to some embodiments of the present disclosure;

FIG. 5 illustrates a flow block diagram of an example process of training a video encoder according to some embodiments of the present disclosure;

FIG. 6 illustrates a schematic structural block diagram of an example apparatus for generating audio according to some embodiments of the present disclosure; and

FIG. 7 illustrates a block diagram of an electronic device capable of implementing a plurality of embodiments of the present disclosure.

### DETAILED DESCRIPTION

Embodiments of the present disclosure are described in more detail below with reference to the drawings. Although some embodiments of the present disclosure are shown in the drawings, it would be appreciated that the present disclosure may be implemented in various forms, and should not be construed as being limited to the embodiments set forth herein. Instead, these embodiments are provided for a more thorough and complete understanding of the present disclosure. It would be appreciated that the drawings and embodiments of the present disclosure are only used for illustrative purposes, and are not intended to limit the scope of protection of the present disclosure.

It would be noted that the titles of any sections/subsections provided herein are not restrictive. Various embodiments are described throughout this specification, and any type of embodiments may be included under any section/subsection. In addition, the embodiments described in any section/subsection may be combined with any other embodiments described in the same section/subsection and/or different sections/subsections in any manner.

In the description of the embodiments of the present disclosure, the term "include/comprise" and similar terms thereof would be understood as open-ended inclusions, that is, "include/comprise but not limited to". The term "based on" would be understood as "at least partially based on". The term "one embodiment" or "the embodiment" would be understood as "at least one embodiment". The term "some embodiments" would be understood as "at least some embodiments". Other explicit and implicit definitions may also be included below. The terms "first" and "second" etc. may refer to different or same objects. Other explicit and implicit definitions may also be included below.

The embodiments of the present disclosure may involve user's data, data acquisition, and/or data use etc., which shall all comply with corresponding laws, regulations, and related provisions. In the embodiments of the present disclosure, all data collection, acquisition, processing, machining, forwarding, and use etc. are performed on the premise that the user is aware of and confirms the same. Accordingly, when implementing the embodiments of the present disclosure, the user should be informed of and authorize the type, range of use, use scenarios etc. of possible data or information involved in an appropriate manner according to relevant laws and regulations. The specific manner of informing and/or authorizing may be changed according to actual situations and application scenarios, and the scope of the present disclosure is not limited in this regard.

If the solutions in this specification and embodiments involve e.g., personal information processing, shall all processed on the premise that there is a legal basis (for example, consent of the personal information subject is obtained, or it is necessary for the fulfillment of a contract etc.), and are only processed within a specified or agreed scope. If the user refuses to process personal information other than necessary information required for basic functions, it will not affect the user's use of the basic functions.

As mentioned above, there are mainly three traditional solutions for generating audio with a machine learning model. The first one is to add voice-overs to video content based on the matching degree between audio representations and video representations. The second one is to extract several frames of images from video content, and use a machine learning model to process the several frames of images to generate a text description corresponding to adapted audio, and then use a machine learning model to process the text description to generate audio. The third one is to construct a machine learning model, and then use the machine learning model to process video content to directly generate audio. The above three schemes all have certain limitations, so the quality of the generated audio needs to be improved.

An embodiment of the present disclosure provides a solution for generating audio. The solution includes: processing video content with a video encoder to determine a video feature; and processing the video feature with a generation model to generate a target audio, where the video encoder is trained based on following processes: obtaining a sample video and a sample audio; determining a first feature representation of the sample video with the video encoder, and determining a second feature representation of the sample audio with an audio encoder; determining a training loss based on the first feature representation, the second feature representation, and reference information, the reference information indicating whether the sample video and the sample audio correspond to a same media file; and training the video encoder based on the training loss.

In this way, when generating a target audio with video content, the embodiment of the present disclosure may more accurately extract a video feature that requires voice-over from the video content, so that the generation model can more accurately generate the target audio according to the video feature, thereby improving the audio quality of the target audio.

Various example implementations of the solution are described below in detail in conjunction with the drawings.

### Example Environment

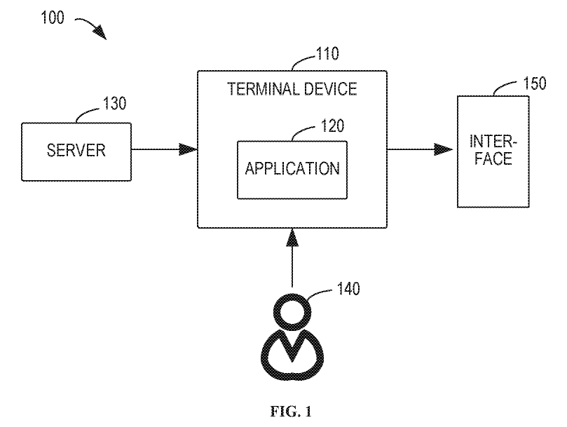

FIG. 1 illustrates a schematic diagram of an example environment 100 in which embodiments of the present disclosure may be implemented. As shown in FIG. 1, the example environment 100 may include a terminal device 110.

In the example environment 100, the terminal device 110 may run an application 120 supporting audio generation. The application 120 may be any appropriate type of application for generating audio, examples of which may include but are not limited to: an audio processing application or other appropriate applications. A user 140 may interact with the application 120 via the terminal device 110 and/or its attached devices.

In the environment 100 of FIG. 1, if the application 120 is active, the terminal device 110 may present an interface 150 for supporting audio generation through the application 120.

In some embodiments, the terminal device 110 communicates with a server 130 to implement the provision of the service to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a Personal Communication System (PCS) device, a personal navigation device, a Personal Digital Assistant (PDA), an audio/video player, a digital camera/video camera, a positioning device, a television receiver, a radio broadcast receiver, an e-book device, a game device, or any combination thereof, including the accessories and peripherals of these devices, or any combination thereof. In some embodiments, the terminal device 110 may also support any type of interface for the user 140 (such as a "wearable" circuit, etc.).

The server 130 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, as well as big data and artificial intelligence platforms. The server 130 may include, for example, a computing system/server, such as a mainframe, an edge computing node, a computing device in a cloud environment, and so on. The server 130 may provide a background service for the application 120 supporting audio generation in the terminal device 110.

A communication connection may be established between the server 130 and the terminal device 110. The communication connection may be established by a wired or wireless manner. The communication connection may include but is not limited to a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the server 130 and the terminal device 110 may implement signaling interaction through the communication connection therebetween.

It would be appreciated that the structure and function of each element in the environment 100 are described for illustrative purposes only, and do not imply any limitation on the scope of the present disclosure.

Some example embodiments of the present disclosure are described below with continued reference to the drawings.

### Example Process

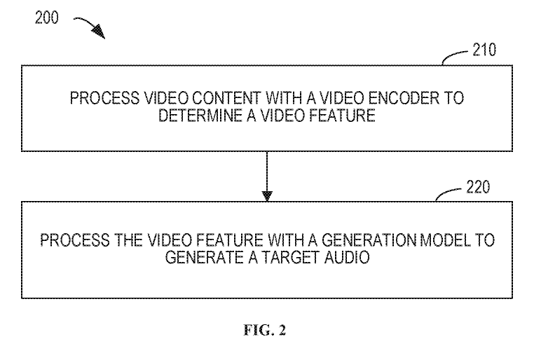

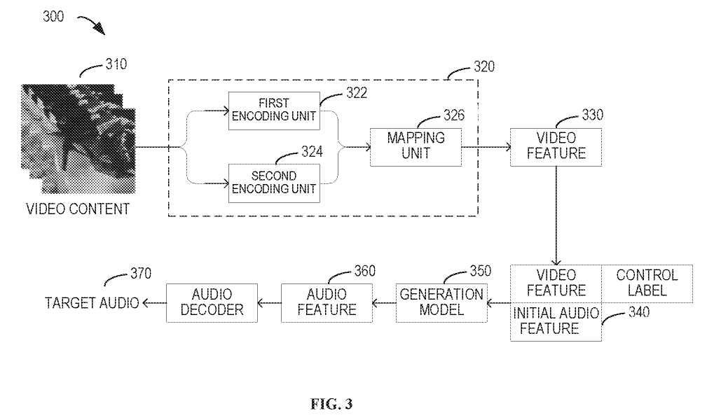

The specific process of generating audio is described below in conjunction with FIGS. 2 and 3. FIG. 2 illustrates a flowchart of an example process 200 of generating audio according to some embodiments of the present disclosure. FIG. 3 illustrates a flow block diagram of an example process 300 of generating audio according to some embodiments of the present disclosure. The process 200 may be implemented at the terminal device 110. The process 200 is described below with reference to FIGS. 1 and 3.

As shown in FIG. 2, at block 210, the terminal device 110 processes video content 310 with a video encoder 320 to determine a video feature 330.

In some embodiments, the video content 310 may be, for example, a film and television segment or a game scene, etc. As an example, the terminal device 110 may obtain the video content 310 through other input devices such as a shooting device or a screen recording device. As another example, the video content 310 may also include video content generated using an appropriate machine learning method. For example, the terminal device 110 may obtain a prompt input by the user, and process the prompt with a generative model to generate corresponding video content 310.

In some embodiments, the video content 310 obtained by the terminal device 110 may be processed video content 310. The processing operation on the video content 310 may be, for example, mute. Additionally, mute processing may be performed in combination with the video content 310. For example, when the video content 310 contains a scene of musical instrument playing, the sound of the musical instrument needs to be retained when muting the video content 310.

In some embodiments, the video encoder 320 is configured to extract video features 330 in the video content 310, so as to subsequently generate a target audio 370 according to these video features 330. Here, the video features 330 may indicate a predetermined object that may trigger a sound effect. As an example, the predetermined object may be an action of a person or an animal, such as a person speaking or a bird chirping. The terminal device 110 accurately extracts these video features 330 from the video content 310 by using the video encoder 320, which may improve the audio quality of the generated target audio 370.

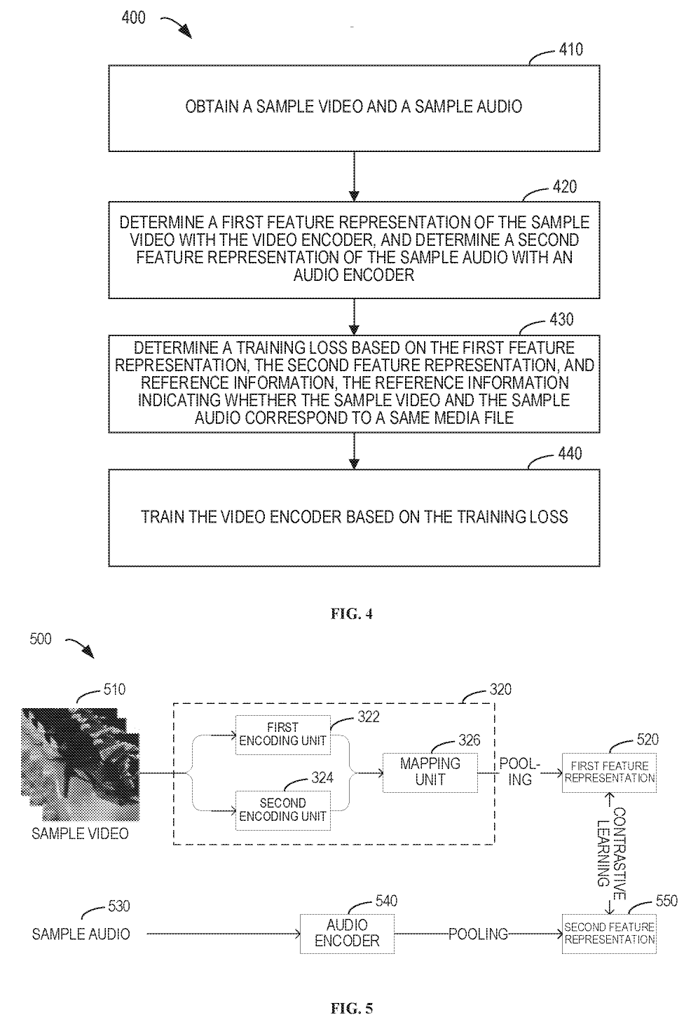

The specific training process of a video encoder 320 is described below in conjunction with FIGS. 4 and 5. FIG. 4 illustrates a flowchart of an example process 400 of training the video encoder 320 according to some embodiments of the present disclosure. FIG. 5 illustrates a flow block diagram of an example process 500 of training the video encoder 320 according to some embodiments of the present disclosure. It would be appreciated that the process 400 and/or the process 500 may be executed by an appropriate electronic device. For example, the terminal device 110 or the server 130. The process 600 is described below by taking the server 130 as an example.

Referring to FIG. 4, at block 410, the server 130 obtains a sample video 510 and a sample audio 530.

In some embodiments, the sample video 510 and the sample audio 530 may correspond to a same media file. That is, the video content split from the same media file is the sample video 510, and the audio content split from the same media file is the sample audio 530. As an example, in the process of training the video encoder 320, the server 130 may take a plurality of set of corresponding sample videos 510 and sample audio 530 for training.

At block 420, the server 130 determines a first feature representation 520 of the sample video 510 with the video encoder 320, and determines a second feature representation 550 of the sample audio 530 with an audio encoder 540.

In some embodiments, the first feature representation 520 may indicate features in the sample video 510, such as a person, an object, or an action occurred in the sample video 510. As an example, the first feature representation 520 may include a dynamic feature representation and a static feature representation. The dynamic feature representation may indicate an action occurred in the sample video 510. The static feature representation may indicate a person or an object in the sample video 510. The server 130 determines the dynamic feature representation and the static feature representation of the sample video 510 with the video encoder 320, which may fully understand the content of the sample video 510, so as to generate a corresponding audio.

By training the video encoder 320, the video encoder 320 may fully understand the video content 310 to extract the corresponding first feature representation 520 therefrom, that is, to extract the first feature representation 520 including the dynamic feature representation and the static feature representation therefrom.

In some embodiments, the video encoder 320 may be composed of a plurality of models. The video encoder 320 may include, for example, a first encoding unit 322 and a second encoding unit 324. Based on this, the specific process of the server 130 processing the sample video 510 with the video encoder 320 to generate the first feature representation 520 may be as follows:

First, the server 130 processes the sample video 510 with the first encoding unit 322 to generate the dynamic feature representation. Here, the first encoding unit 322 may extract actions occurred in the sample video 510.

In some embodiments, before processing the sample video 510 with the first encoding unit 322, the server 130 may process the sample video 510. For example, the server 130 may split the sample video 510 into a plurality of sets of video pictures according to unit time. As an example, the unit time may be in frames, that is, the sample video 510 may be split into a plurality of sets of image frames. Specifically, the server 130 may divide a target number of any adjacent image frames in the sample video 510 into a set of image frames, thereby obtaining a plurality of sets of image frames. Here, the target number may be, for example, 5, which may be adjusted adaptively according to actual situations.

Further, the server 130 inputs each set of image frames successively into the first encoding unit 322, and extracts all feature representations therefrom to form the dynamic feature representation.

As an example, the first encoding unit 322 may be, for example, a convolutional neural network with three-dimensional recognition capability.

Then, the server 130 processes the sample video 510 with the second encoding unit 324 to generate the static feature representation. Here, the second encoding unit 324 may extract persons or an objects in the sample video 510.

In some embodiments, the server 130 may process, with the second encoding unit 324, a plurality of sets of image frames obtained via splitting the sample video 510 to generate the static feature representation. Specifically, the server 130 inputs each image frame in each set of image frames successively into the second encoding unit 324, and extracts all feature representations therefrom to form the static feature representation. As an example, the second encoding unit 324 may be, for example, an image encoder.

The generated dynamic feature representation and static feature representation are further described below with a specific example.

In one example, the sample video 510 describes a scene of a person nailing a nail on a wall with a hammer. The first encoding unit 322 recognizes the action of nailing from the sample video 510. The second encoding unit 324 may recognize a hammer, a wall and a nail from the sample video 510. The action of nailing is the dynamic feature representation, and the hammer, the wall and the nail are the static feature representation.

Finally, the server 130 determines the first feature representation 520 based on the dynamic feature representation and the static feature representation.

In some embodiments, the specific process of determining the first feature representation 520 by the server 130 may be: first, concatenating the dynamic feature representation and the static feature representation to determine an intermediate feature representation; and then, processing the intermediate feature representation with a mapping unit 326 to generate the first feature representation 520.

As an example, the dynamic feature representation and the static feature representation may be concatenated in a manner of concatenating tensors to determine the intermediate feature representation. The dynamic feature representation and the static feature representation may be represented, for example, by tensors indicating dimensions.

Specifically, the tensor of the sample video 510 may be set to [T, W, H, D]. Here, T is the number of frames of the video, W is the width of the video, H is the height of the video, and D is the number of channels of the video. For example, the tensor of a one-second video is [8, 224, 224, 3]. The server 130 inputs the sample video 510 with the tensor of [T, W, H, D] into the first encoding unit 322 and the second encoding unit 324, respectively, and may obtain a first tensor representing the dynamic feature representation and a second tensor representing the static feature representation. The tensor representing the intermediate feature representation may be obtained by concatenating the first tensor corresponding to the dynamic feature representation and the second tensor corresponding to the static feature representation. The tensor corresponding to the first feature representation 520 may be obtained by processing the tensor representing the intermediate feature representation with the mapping unit 326. The tensor indicating the first feature representation 520 may be a tensor with a dimension of [Ta, Da].

Additionally, when processing the intermediate feature representation with the mapping unit 326, a transformer structure may also be utilized to process the intermediate feature representation collectively, so as to improve the ability to extract features in the intermediate feature representation.

In some embodiments, the server 130 may process the sample audio 530 with the audio encoder 540 to obtain the second feature representation 550. As an example, the audio encoder 540 may be a one-dimensional convolutional neural network.

Additionally, before processing the sample audio 530 with the audio encoder 540, the server 130 may preprocess the sample audio 530. For example, the server 130 may determine a Mel spectrogram corresponding to the sample audio 530, so as to process the Mel spectrogram with the audio encoder 540, thereby generating the second feature representation 550.

As an example, the second feature representation 550 may be represented by a tensor indicating a dimension. Specifically, the tensor of the Mel spectrogram of the sample audio 530 may be set to [T, D]. Here, T is the number of frames of the audio, and D is the dimension of the Mel spectrogram. For example, the tensor of a one-second audio is [128, 64]. The server 130 may obtain the tensor indicating the second feature representation 550 by inputting the Mel spectrogram into the audio encoder 540. Additionally, after processing the Mel spectrogram with the audio encoder 540, the server 130 may further perform a further processing with a downsampling layer or a pooling layer for to obtain the tensor indicating the second feature representation 550, thereby matching the tensor corresponding to the second feature representation 550 with the tensor of the first feature representation 520.

At block 430, the server 130 determines a training loss based on the first feature representation 520, the second feature representation 550, and reference information. Here, the reference information indicates whether the sample video 510 and the sample audio 530 correspond to a same media file.

It would be appreciated that the server 130 utilize the first feature representation 520 and the second feature representation 550 for contrastive learning, which may enable the video encoder 320 to learn a corresponding relationship between video content and audio content, so as to more accurately extract the video feature 330 from the video content 310 to be processed.

The training process of the model is further described below. In some embodiments, the training of the video encoder 320 may be based on contrastive training.

As an example, the training loss may consist of two parts. A first part may indicate that the first feature representation 520 and the second feature representation 550 are relatively similar when the sample video 510 and the sample audio 530 correspond to the same media file. The second part may indicate that the first feature representation 520 and the second feature representation 550 have obvious differences when the sample video 510 and the sample audio 530 correspond to different media files.

That is, the training loss may be constructed such that a first similarity between a first pair of feature representations (i.e., a video feature and an audio feature) corresponding to the same media file is greater than a second similarity between a second pair of feature representations (i.e., a video feature and an audio feature) corresponding to different media files.

The training loss determined above is only configured to improve the learning ability of the video encoder 320 to the matching relationship between a plurality of sample videos 510 and a plurality of sample audio 530. Additionally, the server 130 may further design the training loss to further improve the learning ability of the video encoder 320.

In some embodiments, the server 130 may divide the sample video 510 into a plurality of video segments to facilitate contrastive learning. At the same time, the server 130 correspondingly divides the sample audio 530 into a plurality of audio segments. The server 130 may process each video segment with the video encoder 320 and process each audio segment with the audio encoder 540 to obtain a plurality of first feature representations 520 and multiple second feature representations 550. By utilizing the plurality of first feature representations 520 and the plurality of second feature representations 550 for contrastive learning, the audio segment corresponding to each video segment may be determined one by one, thereby improving the ability of the video encoder 320 to extract the video feature 330.

In such example, the reference information may further indicate whether the sample video 510 and the sample audio 530 correspond to a same segment. In this training scenario, the training loss may consist of two parts. The first part may indicate that the first feature representation 520 and the second feature representation 550 are relatively similar when the sample video 510 and the sample audio 530 correspond to the same segment in the same media file. The second part may indicate that the first feature representation 520 and the second feature representation 550 have obvious differences when the sample video 510 and the sample audio 530 correspond to different segments of the media file.

That is, the training loss may be constructed such that a third similarity between a third pair of feature representations (i.e., a video feature and an audio feature) corresponding to the same segment of the media file is greater than a fourth similarity between a fourth pair of feature representations (i.e., a video feature and an audio feature) corresponding to different segments of the media file.

As an example, the first similarity and the third similarity may both be 1, and the second similarity and the fourth similarity may both be 0.

The training loss determined in the above manner may be configured to improve the learning ability of the video encoder 320 to the matching relationship between a plurality of video segments and a plurality of audio segments.

Additionally, before determining the training loss based on the first feature representation 520 and the second feature representation 550, the server 130 may further compress the first feature representation 520 and the second feature representation 550 to determine the training loss based on the compressed first feature representation 520 and the compressed second feature representation 550. In a specific example, the process of compressing the first feature representation 520 and the second feature representation 550 may be: the tensor of the first feature representation 520 is [Ta, Da], the first feature representation 520 being processed with the first pooling layer to generate the compressed first feature representation 520, and the tensor of the compressed first feature representation 520 is [1, Da]. The tensor of the second feature representation 550 is [Tb, Db], the second feature representation 550 being processed with the second pooling layer to generate the compressed second feature representation 550, and the tensor of the compressed second feature representation 550 is [1, Db].

At block 440, the server 130 trains the video encoder 320 based on the training loss.

In some embodiments, the server 130 may adjust the parameters of the video encoder 320 by minimizing the training loss until the training converges. The server 130 may freeze the parameters of the trained video encoder 320 for subsequent processing.

Referring to FIGS. 2 and 3, at block 220, the terminal device 110 processes the video feature 330 with the generation model 350 to generate the target audio 370.

In some embodiments, the target audio 370 may include sound effect content associated with the video content 310, which may be audio that fully matches the video content 310. The fully match here means that each frame of audio matches each frame of video pictures. The target audio 370 may include voice or sound effects. The sound effects may be, for example, a sound effect of playing basketball, a sound effect of clapping, or chirping of birds.

In some embodiments, the terminal device 110 may generate the target audio 370 based on the following process: first, constructing an input feature sequence based on the video feature 330 and an initial audio feature 340, Here, the initial audio feature is 340. And then, the input feature sequence is processed with the generation model 350 to generate the target audio 370.

In some embodiments, the generation module 580 may be a diffusion model, which may convert the video feature 330 into an audio feature 360, so that the terminal device 110 may generate audio corresponding to the video content 310 based on the audio feature 360.

It would be appreciated that the principle of converting the video feature 330 into the audio feature 360 by the generation module 580 is: the generation module 580 performs denoising processing associated with the video content 310 on the initial audio feature 340 to generate the audio feature 360 corresponding to the video content 310. The initial audio 570 may be determined based on initial noise. Specifically, in the training process, the initial audio feature 340 may correspond to a noise addition result of the audio content, and the noise addition result of the audio content is the initial noise. In the inference process, the initial audio feature 340 may correspond to random noise content, and the random noise content is the initial noise.

In some embodiments, in order to facilitate the process of performing denoising processing associated with the video content 310 on the initial audio feature 340, the terminal device 110 needs to first construct an input feature sequence based on the video feature 330 and the initial audio feature 340. The process of constructing the input feature sequence by the terminal device 110 may be: concatenating the first feature representation 520 and the initial audio feature 340 to form the input feature sequence.

As an example, the concatenation of the first feature representation 520 and the initial audio feature 340 may be achieved in a manner of concatenating tensors.

Specifically, the video feature 330 is consistent with the first feature representation 520, and it may be represented by a tensor indicating a dimension. For example, the tensor of the video feature 330 may be [T1, D1]. Here, T1 is the number of frames of the video content 310, and D1 is the dimension of the video content 310. The audio tensor of the initial audio feature 340 may be [T2, D2]. Here, T2 is the number of frames of the initial audio feature 340, and D2 is the dimension of the initial audio feature 340.

The process of concatenating the first feature representation 520 and the initial audio feature 340 by the terminal device 110 may be, for example: first, processing the video feature based on the audio tensor corresponding to the initial audio feature 340; and then, constructing the input feature sequence based on the audio tensor and a third tensor corresponding to the processed video feature 330.

It would be appreciated that the tensor of the video feature 330 is different in length from the audio tensor of the initial audio feature 340, therefore, the tensor of the video feature 330 needs to be processed to make the tensor of the video feature 330 the same in length as the audio tensor of the initial audio feature 340. At this time, the processed video feature 330 corresponds to the third tensor. For example, the terminal device 110 may perform upsampling layer or downsampling layer on the video feature 330 to make the tensor of the video feature 330 the same in length as the audio tensor of the initial audio feature 340.

Further, the process of constructing the input feature sequence by the terminal device 110 based on the audio tensor and the third tensor corresponding to the processed video feature 330 may be: determining a target number of frames based on the number of frames of the audio tensor; determining a target dimension based on a dimension of the audio tensor and a dimension of the third tensor; constructing the input feature sequence based on the target number of frames and the target dimension. Here, the target dimension may be, for example, a sum of the dimension of the audio tensor and the dimension of the third tensor. The input feature sequence is a tensor composed of the target number of frames and the target dimension, that is, [T2, D2+D3], where D3 is the dimension of the third tensor.

Subsequently, the terminal device 110 performs denoising processing with the generation module 580 on the initial audio feature 340 in the input feature sequence to generate the audio feature 360 corresponding to the video content 310. Additionally, the generation module 580 may increase the control to the audio signal, such as the type of the initial audio feature 340, and may also improve the quality of the generated audio feature 360.

In some embodiments, the generation model 350 may be trained based on a generation loss. The training process may be implemented, for example, in the server 130. The generation loss may be, for example, MSE loss. The server 130 may adjust the parameters of the generation module 580 by minimizing the training generation loss until the training converges.

The audio feature 360 generated via the trained generation module 580 may be restored to the target audio 370 by an audio decoder. Further, the video content 310 may be processed with the trained video encoder 320 and generation module 580, and the target audio 370 may be generated, thereby realizing automatic voice-over addition to the video content 310.

Additionally, when the server 130 trains the video encoder 320 and the generation model 350, a control label may be determined based on the sample audio 530. The control label may indicate an audio attribute of the sample audio 530. The audio attribute may be, for example, audio quality or the type of sound effect included in the audio. The server 130 may determine the control label by analyzing the sample audio 530. While determining the control label, the server 130 may also separate various sound effects from the sample audio 530.

Further, in the inference stage of the video encoder 320 and the generation module 580, the server 130 may generate the target audio 370 based on an adjustment of the control label.

In some embodiments, the control label indicates all sound effects included in the sample audio 530, and each sound effect corresponds to a control amount. The control amount may be, for example, has a control range from 0 to 1. The server 130 may adjust the corresponding control amount according to the type of sound effect, thereby adjusting the target audio 370.

In a specific example, the sample audio 530 has an environmental sound effect a therein. When determining the corresponding control label, the server 130 separates the environmental sound effect a from the sample audio 530. When the server 130 restores to obtain the target audio 370 with the audio decoder, the target audio 370 does not have the environmental sound effect a therein. At this time, the server 130 adjusts the control label (i.e., adjusts the control amount of the environmental sound effect a to 1), so that the environmental sound effect a is superimposed on the target audio 370, thereby obtaining the final target audio 370.

The server 130 trains the video encoder 320 and the generation module 580 through the above process, which may improve the audio quality of the generated target audio 370.

### Example Apparatus and Device

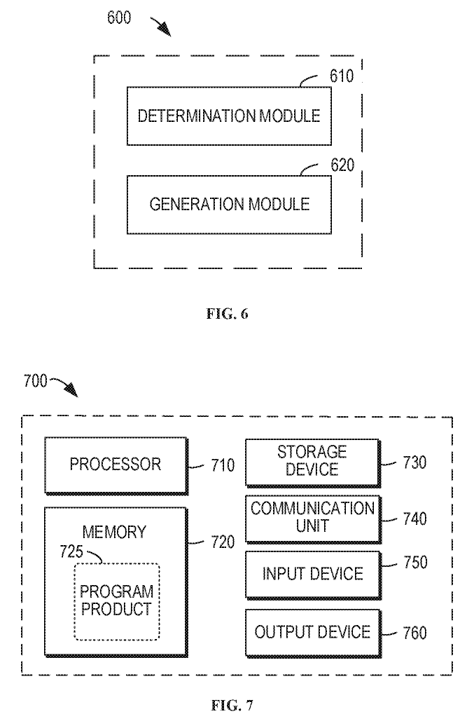

The embodiments of the present disclosure further provides a corresponding apparatus for implementing the above method or process. FIG. 6 illustrates a schematic structural block diagram of an example apparatus 600 for generating audio according to some embodiments of the present disclosure. The apparatus 600 may be implemented as the terminal device 110 or included in the terminal device 110. Each module/component in the apparatus 600 may be implemented by hardware, software, firmware, or any combination thereof.

As shown in FIG. 7, the apparatus 600 includes: a determination module 610, configured to process video content with a video encoder to determine a video feature; and a generation module 620, configured to process the video feature with a generation model to generate a target audio, wherein the video encoder is trained based on following processes: obtaining a sample video and a sample audio; determining a first feature representation of the sample video with the video encoder, and determining a second feature representation of the sample audio with an audio encoder; determining a training loss based on the first feature representation, the second feature representation, and reference information, the reference information indicating whether the sample video and the sample audio correspond to a same media file; and training the video encoder based on the training loss.

In some embodiments, the target audio includes sound effect content associated with the video content.

In some embodiments, the video encoder includes a first encoding unit and a second encoding unit, and determining the first feature representation of the sample video with the video encoder includes: processing a plurality of image frames of the sample video with the first encoding unit to generate a dynamic feature representation; processing the sample video with the second encoding unit to generate a static feature representation; and determining the first feature representation based on the dynamic feature representation and the static feature representation.

In some embodiments, determining the first feature representation based on the dynamic feature representation and the static feature representation includes: concatenating the dynamic feature representation and the static feature representation to determine an intermediate feature representation; and processing the intermediate feature representation with a mapping unit to generate the first feature representation.

In some embodiments, concatenating the dynamic feature representation and the static feature representation to determine the intermediate feature representation includes: concatenating a first tensor corresponding to the dynamic feature representation and a second tensor corresponding to the static feature representation to determine the intermediate feature representation.

In some embodiments, determining the second feature representation of the sample audio using the audio encoder includes: determining a mel spectrogram corresponding to the sample audio; and processing the mel spectrogram with the audio encoder to generate the second feature representation.

In some embodiments, the apparatus 600 further includes: processing the first feature representation with a first pooling layer to generate a compressed first feature representation; processing the second feature representation with a second pooling layer to generate a compressed second feature representation; and determining the training loss based on the compressed first feature representation, the compressed second feature representation, and the reference information.

In some embodiments, determining the training loss based on the first feature representation, the second feature representation, and the reference information includes: determining the training loss based on the reference information, such that a first similarity between a first pair of feature representations corresponding to a same media file is greater than a second similarity between a second pair of feature representations corresponding to different media files.

In some embodiments, the reference information further indicates whether the sample video and the sample audio correspond to a same segment in a media file, and the training loss is determined based on the reference information, such that a third similarity between the first pair of feature representations corresponding to a same segment in a media file is greater than a fourth similarity between a fourth pair of feature representations corresponding to different segments in the media file.

In some embodiments, processing the video feature with the generation model to generate the target audio includes: constructing an input feature sequence based on the video feature and an initial audio feature, the initial audio feature being determined based on initial noise; and processing the input feature sequence with the generation model to generate the target audio.

In some embodiments, constructing the input feature sequence based on the video feature and the initial audio feature includes: processing the video feature based on an audio tensor corresponding to the initial audio feature; and constructing the input feature sequence based on the audio tensor and a third tensor corresponding to the processed video feature.

In some embodiments, constructing the input feature sequence based on the audio tensor and the third tensor corresponding to the processed video feature includes: determining a target number of frames based on the number of frames of the audio tensor; determining a target dimension based on a dimension of the audio tensor and a dimension of the third tensor; and constructing the input feature sequence based on the target number of frames and the target dimension.

As shown in FIG. 7, the electronic device 700 is in the form of a general electronic device. The components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor, and may perform various processing based on the programs stored in the memory 720. In a multi-processor system, multiple processing units execute computer executable instructions in parallel to improve the parallel processing capability of the electronic device 700.

The electronic device 700 typically includes multiple computer storage medium. Such medium may be any available medium accessible by the electronic device 700, including but not limited to volatile and non-volatile medium, removable and non-removable medium. The memory 720 may be volatile memory (for example, a register, cache, a Random Access Memory (RAM)), a non-volatile memory (such as a Read-Only Memory (ROM), an Electrically Erasable Programmable Read-Only Memory (EEPROM), a flash memory), or any combination thereof. The storage device 730 may be any removable or non-removable medium, and may include a machine-readable medium such as a flash drive, a disk, or any other medium, which may be used to store information and/or data and may be accessed within the electronic device 700.

The electronic device 700 may further include additional removable/non-removable, volatile/non-volatile memory medium. Although not shown in FIG. 7, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 implements communication with other electronic devices through the communication medium. Additionally, the functions of the components of the electronic device 700 may be implemented by a single computing cluster or multiple computing machines, which may communicate through communication connections. Therefore, the electronic device 700 may use a logical connection with one or more other servers, a network personal computer (PC), or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may further communicate with one or more external devices (not shown) through the communication unit 740 as needed (the external devices such as a storage device, a display device, etc.); communicate with one or more devices that enable the user to interact with the electronic device 700; or communicate with any devices (for example, a network card, a modem, etc.) that enable the electronic device 700 to communicate with one or more other electronic devices. Such communication may be performed via input/output (I/O) interfaces (not shown).

According to an illustrative implementation of the present disclosure, a computer-readable storage medium is provided, on which computer executable instructions are stored, where the computer executable instructions are executed by a processor to implement the method described above. According to an illustrative implementation of the present disclosure, a computer program product is further provided. The computer program product is tangibly stored on a non-transitory computer-readable medium and includes computer executable instructions, and the computer executable instructions are executed by a processor to implement the method described above.

Various aspects of the present disclosure are described herein with reference to the flowcharts and/or block diagrams of the method, apparatus, device, and computer program product implemented according to the present disclosure. It would be appreciated that each block of the flowcharts and/or block diagrams, and the combination of each block in the flowcharts and/or block diagrams may be implemented by computer readable program instructions.

These computer readable program instructions may be provided to the processing unit of a general-purpose computer, a special-purpose computer, or other programmable data processing apparatus, so as to produce a machine, such that when these instructions are executed by the processing unit of the computer or other programmable data processing apparatus, an apparatus for implementing the functions/actions specified in one or more blocks in the flowcharts and/or block diagrams is produced. These computer readable program instructions may also be stored in the computer-readable storage medium. These instructions make the computer, the programmable data processing apparatus, and/or other devices work in a specific way, so that the computer-readable medium storing the instructions includes a manufactured product, which includes instructions for implementing various aspects of the functions/actions specified in one or more blocks in the flowcharts and/or block diagrams.

The computer readable program instructions may be loaded on a computer, other programmable data processing apparatus, or other devices, such that a series of operation steps are performed on the computer, other programmable data processing apparatus, or other devices to produce a computer-implemented process, so that the instructions executed on the computer, other programmable data processing apparatus, or other devices implement the functions/actions specified in one or more blocks in the flowcharts and/or block diagrams.

The flowcharts and block diagrams in the drawings show the possibly implemented architectures, functions, and operations of the system, method, and computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block in the block diagram and/or flowchart, and the combination of the blocks in the block diagram and/or flowchart may be implemented by a dedicated hardware-based system that performs the specified functions or actions, or by a combination of dedicated hardware and computer instructions.

The implementations of the present disclosure have been described above, and the above description is illustrative, non-exhaustive, and not limited to the disclosed implementations. Without departing from the scope of the described implementations, many modifications and changes would be apparent to those of ordinary skill in the art. The terms used herein are selected to best explain the principles, practical applications, or improvements of the technology in the market of the implementations, or to enable other ordinary skilled persons in the art to understand the various implementations disclosed herein.

1. A method of generating audio, comprising:
processing video content with a video encoder to determine a video feature; and
processing the video feature with a generation model to generate a target audio, wherein the video encoder is trained based on following processes:
obtaining a sample video and a sample audio;
determining a first feature representation of the sample video with the video encoder, and determining a second feature representation of the sample audio with an audio encoder;
determining a training loss based on the first feature representation, the second feature representation, and reference information, the reference information indicating whether the sample video and the sample audio correspond to a same media file; and
training the video encoder based on the training loss.

2. The method of claim 1, wherein the target audio comprises sound effect content associated with the video content.

3. The method of claim 1, wherein the video encoder comprises a first encoding unit and a second encoding unit, and determining the first feature representation of the sample video with the video encoder comprises:
processing a plurality of image frames of the sample video with the first encoding unit to generate a dynamic feature representation;
processing the sample video with the second encoding unit to generate a static feature representation; and
determining the first feature representation based on the dynamic feature representation and the static feature representation.

4. The method of claim 3, wherein determining the first feature representation based on the dynamic feature representation and the static feature representation comprises:
concatenating the dynamic feature representation and the static feature representation to determine an intermediate feature representation; and
processing the intermediate feature representation with a mapping unit to generate the first feature representation.

5. The method of claim 4, wherein concatenating the dynamic feature representation and the static feature representation to determine the intermediate feature representation comprises:
concatenating a first tensor corresponding to the dynamic feature representation and a second tensor corresponding to the static feature representation to determine the intermediate feature representation.

6. The method of claim 1, wherein determining the second feature representation of the sample audio with the audio encoder comprises:
determining a mel spectrogram corresponding to the sample audio; and
processing the mel spectrogram with the audio encoder to generate the second feature representation.

7. The method of claim 1, further comprising:
processing the first feature representation with a first pooling layer to generate a compressed first feature representation;
processing the second feature representation with a second pooling layer to generate a compressed second feature representation; and
determining the training loss based on the compressed first feature representation, the compressed second feature representation, and the reference information.

8. The method of claim 1, wherein determining the training loss based on the first feature representation, the second feature representation, and the reference information comprises:
determining the training loss based on the reference information, such that a first similarity between a first pair of feature representations corresponding to a same media file is greater than a second similarity between a second pair of feature representations corresponding to different media files.

9. The method of claim 1, wherein the reference information further indicates whether the sample video and the sample audio correspond to a same segment in a media file, and
the training loss is determined based on the reference information, such that a third similarity between the first pair of feature representations corresponding to a same segment in a media file is greater than a fourth similarity between a fourth pair of feature representations corresponding to different segments in the media file.

10. The method of claim 1, wherein processing the video feature with the generation model to generate the target audio comprises:
constructing an input feature sequence based on the video feature and an initial audio feature, the initial audio feature being determined based on initial noise; and
processing the input feature sequence with the generation model to generate the target audio.

11. The method of claim 10, wherein constructing the input feature sequence based on the video feature and the initial audio feature comprises:
processing the video feature based on an audio tensor corresponding to the initial audio feature; and
constructing the input feature sequence based on the audio tensor and a third tensor corresponding to the processed video feature.

12. The method of claim 11, wherein constructing the input feature sequence based on the audio tensor and the third tensor corresponding to the processed video feature comprises:
determining a target number of frames based on the number of frames of the audio tensor;
determining a target dimension based on a dimension of the audio tensor and a dimension of the third tensor; and
constructing the input feature sequence based on the target number of frames and the target dimension.

13. An electronic device, comprising:
at least one processor; and
at least one memory coupled to the at least one processor, the at least one memory storing instructions for execution by the at least one processor, the instructions, when executed by the at least one processor, causing the electronic device to perform acts comprising:
processing video content with a video encoder to determine a video feature; and
processing the video feature with a generation model to generate a target audio, wherein the video encoder is trained based on following processes:
obtaining a sample video and a sample audio;
determining a first feature representation of the sample video with the video encoder, and determining a second feature representation of the sample audio with an audio encoder;
determining a training loss based on the first feature representation, the second feature representation, and reference information, the reference information indicating whether the sample video and the sample audio correspond to a same media file; and
training the video encoder based on the training loss.

14. The electronic device of claim 13, wherein the target audio comprises sound effect content associated with the video content.

15. The electronic device of claim 13, wherein the video encoder comprises a first encoding unit and a second encoding unit, and determining the first feature representation of the sample video with the video encoder comprises:
processing a plurality of image frames of the sample video with the first encoding unit to generate a dynamic feature representation;
processing the sample video with the second encoding unit to generate a static feature representation; and
determining the first feature representation based on the dynamic feature representation and the static feature representation.

16. The electronic device of claim 15, wherein determining the first feature representation based on the dynamic feature representation and the static feature representation comprises:
concatenating the dynamic feature representation and the static feature representation to determine an intermediate feature representation; and
processing the intermediate feature representation with a mapping unit to generate the first feature representation.

17. The electronic device of claim 16, wherein concatenating the dynamic feature representation and the static feature representation to determine the intermediate feature representation comprises:
concatenating a first tensor corresponding to the dynamic feature representation and a second tensor corresponding to the static feature representation to determine the intermediate feature representation.

18. The electronic device of claim 13, wherein determining the second feature representation of the sample audio with the audio encoder comprises:
determining a mel spectrogram corresponding to the sample audio; and
processing the mel spectrogram with the audio encoder to generate the second feature representation.

19. The electronic device of claim 13, wherein the acts further comprise:
processing the first feature representation with a first pooling layer to generate a compressed first feature representation;
processing the second feature representation with a second pooling layer to generate a compressed second feature representation; and
determining the training loss based on the compressed first feature representation, the compressed second feature representation, and the reference information.

20. A non-transitory computer-readable storage medium having a computer program stored thereon, the computer program being executable by a processor to implement acts comprising:
processing video content with a video encoder to determine a video feature; and
processing the video feature with a generation model to generate a target audio, wherein the video encoder is trained based on following processes:
obtaining a sample video and a sample audio;
determining a first feature representation of the sample video with the video encoder, and determining a second feature representation of the sample audio with an audio encoder;
determining a training loss based on the first feature representation, the second feature representation, and reference information, the reference information indicating whether the sample video and the sample audio correspond to a same media file; and
training the video encoder based on the training loss.
